(19) United States
(12) Patent Application Publication
(10) Pub. No.: US 2013/0185157 A1
(43) Pub. Date: Jul. 18, 2013

(54) SYSTEMS AND METHODS FOR PRESENTATION AND ANALYSIS OF MEDIA CONTENT

(71) Applicants: Ahmad SHIHADAH, McLean, VA (US); Amro SHIHADAH, McLean, VA (US); Mohammad SHIHADAH, McLean, VA (US)

(72) Inventors: Ahmad SHIHADAH, McLean, VA (US); Amro SHIHADAH, McLean, VA (US); Mohammad SHIHADAH, McLean, VA (US)

(21) Appl. No.: 13/626,065

(22) Filed: Sep. 25, 2012

Related U.S. Application Data
(60) Provisional application No. 61/586,349, filed on Jan. 13, 2012.

(51) Int. Cl. G06Q 30/02

(52) U.S. Cl. 705/14.64

(57) ABSTRACT

Information is provided a user of a mobile device. Media content is sensed by the mobile device and sent to an information processing server. The information processing server also obtains media content from another source and associates at least a portion of the obtained media content with a product or service offer. The sensed media content is correlated to the obtained media content such that an associated buy or service offer is selected. The buy or service offer is sent to the mobile device for display to the user.

### CROSS-REFERENCES TO RELATED APPLICATIONS

This application claims priority from provisional application 61/586,349, filed Jan. 13, 2012, the entire contents of which are hereby incorporated by reference.

### STATEMENT REGARDING FEDERALLY SPONSORED RESEARCH OR DEVELOPMENT

1. Field

The technology herein relates to more effective ways to provide information to consumers of media content. More specifically, the technology herein relates to providing users with new ways of interacting with (e.g., capturing) media content and providing, for example, purchasing opportunities based on the interaction.

2. Background and Summary

Millions of football fans tune in each year to see two teams battle in the Super Bowl for the NFL championship trophy. Because the broadcast viewership for the event is so large (with correspondingly high advertising fees), marketers go to great lengths to create inspirational commercials. Indeed, for some of us, the commercials may be so inspiring that they end up being more interesting than the actual football game. These commercials may then inspire us and end up influencing our purchasing decisions.

Millions of movie goers may also turn out to see the newest James Bond movie that includes a scene with James Bond driving the latest sports car from Aston Martin. Such a sequence, called “product placement,” may not be as direct in attempting to influence our purchasing decisions, but may be just as powerful (if not more so) to inspire us to take a certain action. For example, after seeing this scene you may be inspired to go out and buy a sports car.

Both of the above techniques involve situations in which a marketer is seeking to expressly tie your inspiration in the media content to a particular product. However, there is also a vast collection of media content that does not fall into the commercial or product placement categories. Specifically, other scenes in a James Bond movie that are not directly tied to any particular product may also inspire you action. For example, James Bond jumping out of an airplane may inspire you to sign up for a sky diving adventure. Alternatively, older media content may still be highly inspirational. For example, given the passage of enough time, a product placement provided in an earlier James Bond film may provide you with a different inspiration than the one originally intended. Also, older movies such as the Wizard of Oz and Gone With The Wind are still capable of inspiring viewers, but they may inspire viewers to do or buy different things now as compared to when those films were first released back in 193.

Marketers and users would benefit if such inspirations could be tapped and targeted to provide users with opportunities for action on their inspirations when viewing media content. Thus, new and interesting techniques of providing users with such abilities may be desirable.

In certain example embodiments, a media content intake system receives media content and tags portions of the content as being associated with a particular result. In certain example embodiments, the result is a product or a service. In certain example embodiments, the result may include further information (e.g., a make and model of a car that is in the content). A library or database of such tags can be created and maintained.

Consumers are then encouraged to capture and send in portions of media streams they are currently watching, listening to, etc. The portions of the media streams that users capture and send in are analyzed. A comparison is made between the tagged content and the captured media content. When a match is found, the user is sent information associated with the tagged result.

In certain example non-limiting embodiments, automatic identification of TV or movie content and association with product or service offers or location aids is provided via a mobile device. The content may include for example movies, TV shows, advertisements, sports, news, music, entertainment channels, or any form of stimuli that can be sensed and captured electronically. Such content can be delivered live (e.g., a play, a movie, a rock band, etc.) or remotely (e.g., by cable television, via a terrestrial or satellite radio, etc.) The mobile device may operate to capture video, audio, and/or images, and relate them to particular goods and/or services. The user may be presented with more information about the goods/services and/or may be presented with options to purchase the goods and/or services.

In certain example embodiments, one or more software modules may be implemented on a processing system that analyzes media content. For example:

A Media platform module may include functionality that

Creates tagged media content though the automatic processing of channels (e.g., TV channels, internet sources, etc). Tagged information may include:
Program type, for example: movies, documentary, sports (e.g., NFL, NBA), news, music, T.V. shows, commercials (e.g., Advertisements).
Time of transmission or broadcast, for example: country, region, city, channel number, network (e.g., HBO, NBC, ABC).

Provides libraries of searched data, for example on:
Cars
Bicycles
Sports such as golf, football, etc

Provides multi-functionality support for users so that users may interact with certain services in more than one language (e.g., English, Arabic, Spanish)

Accepts uploads advertising content with tagged or associated information, for example:
Scene information
Frames of the advertisement
A logo associated with the advertisement
Speech data (e.g., a finger print for speech in the advertisement)
VOCR (Video Optical Character Recognition) textual data
A telephone number (e.g., for linking to an IVR)
Possible actions that may be taken in relation to the Ad:
   Connect to Purchase good
   Connect to Website

Geographical data, for example: national, regional, or local listings

Automatic Speech Recognition (ASR) engines

### Finger Printing Of Advertisements

### Video Optical Character Recognition (VOCR)

Automatic searches in an image collection
Automatic structure detection from structure
Mobile server Interfaces

### Facial Recognition

User profile that may include information such as, for example,

Name, email, telephone number (e.g., home, work, cell), payment options, billing information, the devices that are registered (e.g., iPhone, Android mobile devices), buying history, wish list, interests, etc

Integration and/or Interface Modules may also be included, for example:
Interactive Voice Response

### Web Servers

Payment methods, for example: PayPal, wallet, mobile
Social Media such as Face book, twitter, and other services

Mobile clients for use by users may be implemented for various mobile device platforms, such as the Apple's iPhone or iPod, the Android platform, or other types of mobile phones, devices, tablets, etc.

Such clients may include functionality that allows integration with pre-existing commercial implementations (e.g., an application store, a music store, or the like).
The client may include user interfaces that allow for easy recordation of content and forwarding to a server for analysis.
The client may include audio, video, and/or image compression technology.

Billing and financial systems may also be integrated with various other systems and/or modules according to certain example embodiments.

In certain example embodiments, a rover module may be used to assist in identifying content. The identification process may use multiple “paths” to increase confidence that the product, service, or other item being identified is correct. For example, video, voice, ISR, and other features of media content may be analyzed simultaneously (or in series) to identify a target piece of media.

In certain example embodiments, a method of providing information to a user of a mobile device that includes at least one imaging system that is configured to obtain media content is provided. The mobile device is operable to communicate with an information processing server. First media content is received from the mobile device, the first media content obtained through the at least one imaging system of the mobile device. Second media content is obtained that is from a media source that is different than the mobile device. At least one product is associated with the second media content. The first media content is processed to obtain at least one feature of the first media content. A matching analysis process is performed on the first media content against the second media content based on the at least one feature. A result to the mobile device is sent that indicates whether or not a match to the first media content was identified.

In certain example embodiments, a processing server system that analyzes of media content that is uploaded via mobile devices by users is provided. The system includes a memory storage medium. The system also includes at least one processor. The at least one processor is structured to receive first media content from a mobile device, the first media content obtained through at least one imaging system that is part of the mobile device. The at least one processor is structured to receive second media content that is from a media source different from the mobile device and store the received second media content in the memory storage medium. The at least one processor is structured to associate at least one product with the second media content. The at least one processor is structured to process the first media content to obtain at least one feature of the first media content. The at least one processor is structured to perform a matching analysis process on the first media content against the second media content based on the at least one feature. The at least one processor is structured to send a result to the mobile device that indicates whether or not a match to the first media content was identified.

In certain example embodiments, a system for analyzing media content and providing buying opportunities to users of a mobile device is provided. The system includes a mobile device including at least one imaging system that is configured to obtain first media content in response to user input. The system includes a processing system that wirelessly communicates with the mobile device. A processing system is structured to receive the first media content that is obtained via the mobile device. A processing system is structured to receive second media content that is from a media source different from the mobile device and store the received second media content in a memory storage medium. A processing system is structured to associate at least one tagged feature with the second media content. A processing system is structured to store at least one product in the storage medium in association with the second media content. A processing system is structured to in response to receipt of the first media content, process the first media content to obtain at least one feature in the first media content. A processing system is structured to perform a matching analysis process on the first media content against the second media content based on comparing the at least one feature to the at least one tagged feature. A processing system is structured to send a result to the mobile device that indicates the at least one product is associated with the first media content in response to a successful matching process.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 shows a user interfacing with an example implementation of a media presentation system according to certain example embodiments;

FIGS. 2A-2B show a user interfacing with an example implementation of a media presentation system according to certain example embodiments;

FIG. 3 shows an exemplary process for processing television content according to certain example embodiments;

FIG. 4 shows an exemplary process for handle Ad content according to certain example embodiments;

FIG. 5 shows an exemplary process for processing direct response televisions according to certain example embodiments;

FIG. 6 shows an exemplary process for promotional ad processing according to certain example embodiments;

FIG. 7 shows an exemplary process for event processing according to certain example embodiments;

FIG. 8A is an exemplary process for matching media content according to certain example embodiments;

FIG. 8B is an exemplary process for buying a product as a result of matched media content;

FIG. 8C is an exemplary process is no matches are initial found in media content;

FIG. 9A is an example block diagram showing content ingestion according to certain example embodiments;

FIG. 9B is an example block diagram for T.V. content processing according to certain example embodiments;

FIG. 10 is an administration module according to certain example embodiments;

FIG. 11 is a block diagram of a content module according to certain example embodiments;

FIG. 12 is a block diagram of an example processing server that includes multiple different modules according to certain example embodiments;

FIG. 13 is a diagram showing example components of systems, apparatus, and services according to certain example embodiments; and

FIG. 14 is an example processing system and interfaces according to certain example embodiments.

### DETAILED DESCRIPTION

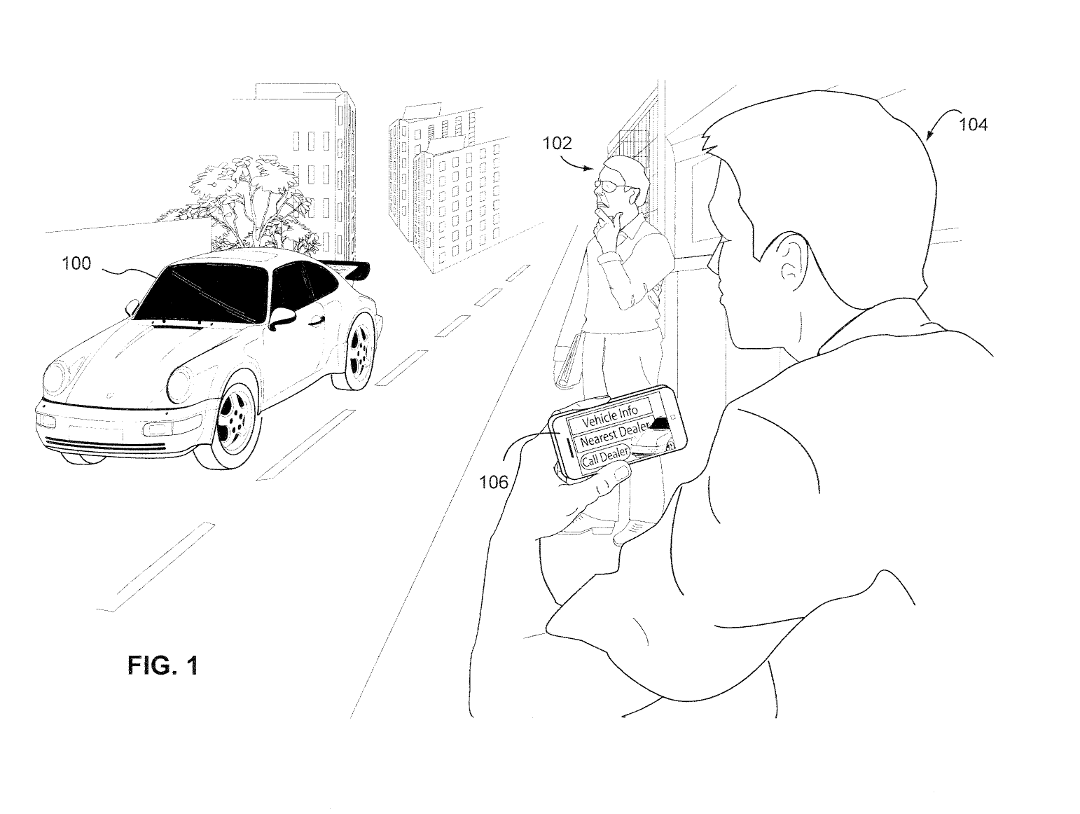

FIG. 1 shows an exemplary scene of two people (Person 102 and Person 104) viewing a car 100 that is driving by on a road. Person 102 would like additional information on the car 100 (indicated by the thoughtful expression). However, other than seeing that the car was red and a Ford, person 102 did not glean any extra information about the car as it drove by. After seeing the car person 102 may wonder: where the nearest Ford dealer is; what type of car was that exactly; what mileage does it get; how much does it cost; are there any used models for sale; are there any comparable models from different car manufacturers? All of these questions may jump through person 102 upon seeing the car. However, as person 102 is on a sidewalk, there is likely no easy way to retrieve the answers to these questions.

Like person 102, person 104 is also intrigued by the car. However, unlike person 102, person 104 has a mobile device that implements a client of a media analysis system. As explained in greater detail below, with such a client, person 104 may take a picture of the car 100 as it passes and sent it to a media analysis system. The media analysis system may then return information related to the identified vehicle. For example, the returned information may include additional vehicle information (e.g., its estimated mpg, price, etc), a map that directs him to the nearest dealer that carries the car, or person 104 may decide to buy the car now. It will be appreciated that other types of information may also be presented to the user.

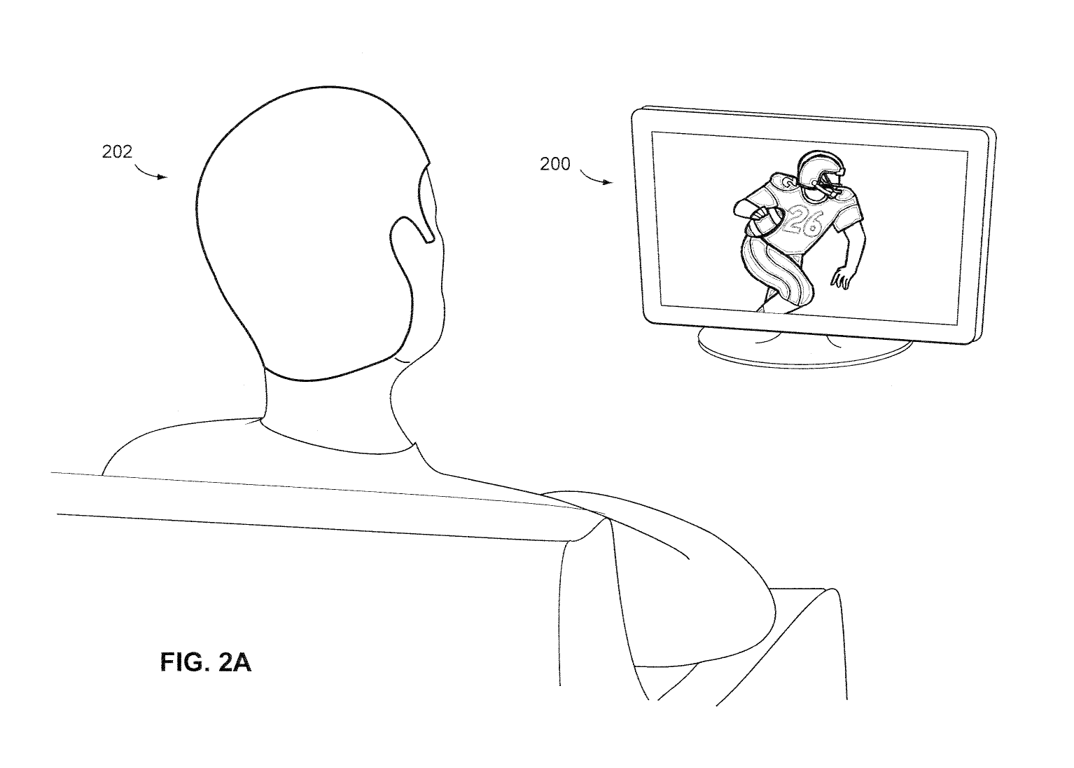

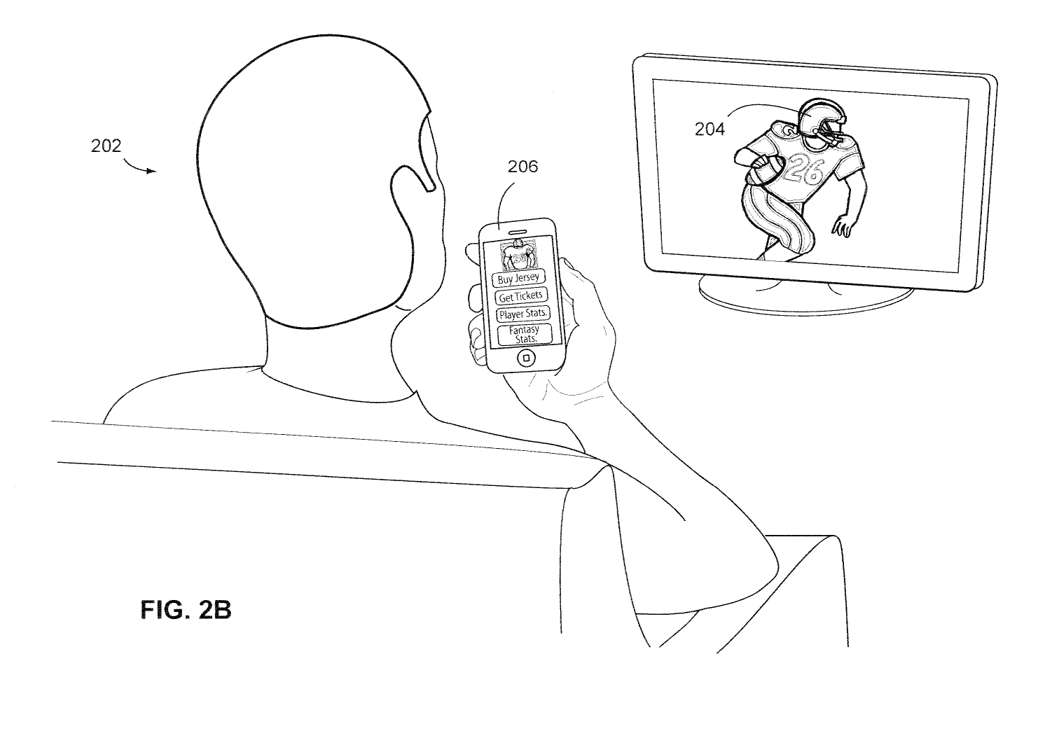

FIGS. 2A-2B show a user interfacing with an example implementation of a media analysis system according to certain example embodiments. In certain example embodiments, a media analysis system may operate in conjunction with television or other broadcast (e.g., radio) content. Here, person 202 is watching a football game on television 200. In the football game being shown on television 200, a football player 204 with a jersey number 26 is holding the football. Football player 204 is a favorite player of person 202. Accordingly, person 202 may take a picture of the television screen. In response to this image may be presented with options to buy the jersey of football player 204, obtain tickets to upcoming football games, obtain player stats, and obtain fantasy stats on football player 204. As with the scene in FIG. 1, other options may be presented to the user (e.g., a weather report where the game is being played, a list of upcoming games with player 204, etc). In any event, by simply taking a picture and forwarding it onto a media analysis system, a person may be able to access a vast variety of information about a particular person, place, product, etc.

In certain example embodiments, instead of taking a picture a user may record a video or short clip (e.g., 5 seconds). This may apply to “real world” content (e.g., where person 104 obtains a video clip of car 100 driving by) or content broadcast through a television, radio, etc.

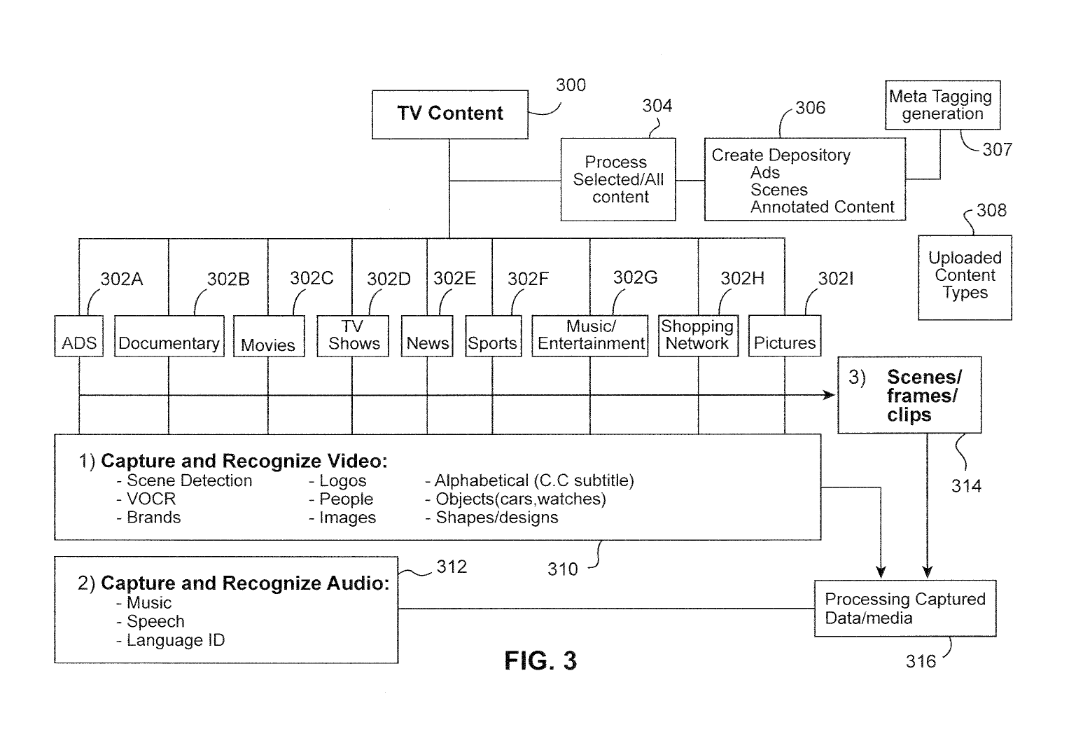

FIG. 3 shows an exemplary process for selecting television content according to certain example embodiments. Television content 300 may include various types of content: advertisements 302A, documentaries 302B, movies 302C, T.V. shows 302D, news programs 302E, sports programs 302F, music and entertainment programs 302G, shopping network programs 302H, pictures 302I, and the like. A process 304 may select one or more (e.g., all) of the television content types that are broadcast. The selection via this process may enable a content repository to be created at 306. The repository may include various content types including advertisements, scenes from programs, annotated content, etc. The process of storing content may also include annotating or “tagging” the content at 307.

In certain example embodiments, the tagging or annotation of a given piece of content may be an automatic process. In certain example embodiments, partner businesses may specify how their products are related to a given piece of content. For example, a photograph of a flower may be associated with “Joe's Flower Shop” or an NFL football game between teams A and B may be associated with a particular athletic drink sponsor. In certain example embodiments, the tagging process may a manual process that is carried out by the provider of the analysis service. For example, all of the scenes for a given T.V. show may be tagged for when a particular car brand that the main character drives is shown. As noted above, this information may also be provided by a business partner. For example, the business may specify that at times X, Y, and Z the car is shown. During these times of the program associate our product with this particular car. Thus, if a user uploads a scene or an image that is within those time periods, the user may be presented with information about the car in question. This process may provide more value to the car company as the show uses their product in the particular show. In other words, certain example embodiments may facilitate more effective product placement (e.g., as the placement is more likely to result in a sale).

In certain example embodiments, users (or businesses) may upload content types (e.g., a picture of the car in FIG. 1) in 308.

The T.V. content that is feed into an example media analysis system may capture video at 310, scenes, frames, clips, etc at 314, and/or audio at 312. In certain example embodiments, captured video may be recognized through the detection of a given scene of a program (e.g., the first play of the second quarter in a football game). In certain example embodiments, video content may be analyzed or recognized through the use of Video Optical Character Recognition (VOCR) techniques (e.g., through use of software/hardware/firmware packages). In certain example embodiments, captured audio may be recognized through identification of words spoken. In certain example embodiments, additional processing may take place to automatically identify products, screens, etc. The various types of information captured may be feed into for a processing of data and/or media at 316.

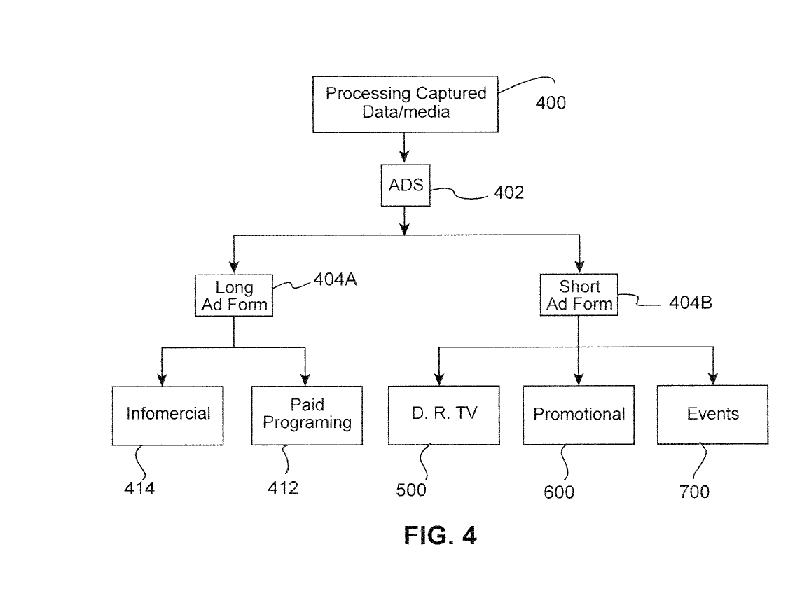

FIG. 4 shows an exemplary process for handling advertising content according to certain example embodiments. The processing of data/media at 400 may involve a determination that the media is an advertisement at 402. A further determination may be made as to whether the ad is a long advertising form 404A or a short advertising form 404B. In certain example embodiments, long ad forms may include infomercials 414, or paid programming 412. In certain example embodiments, short ad forms may include direct response television advertisements 500, promotional advertisements 600, or event advertisements 700.

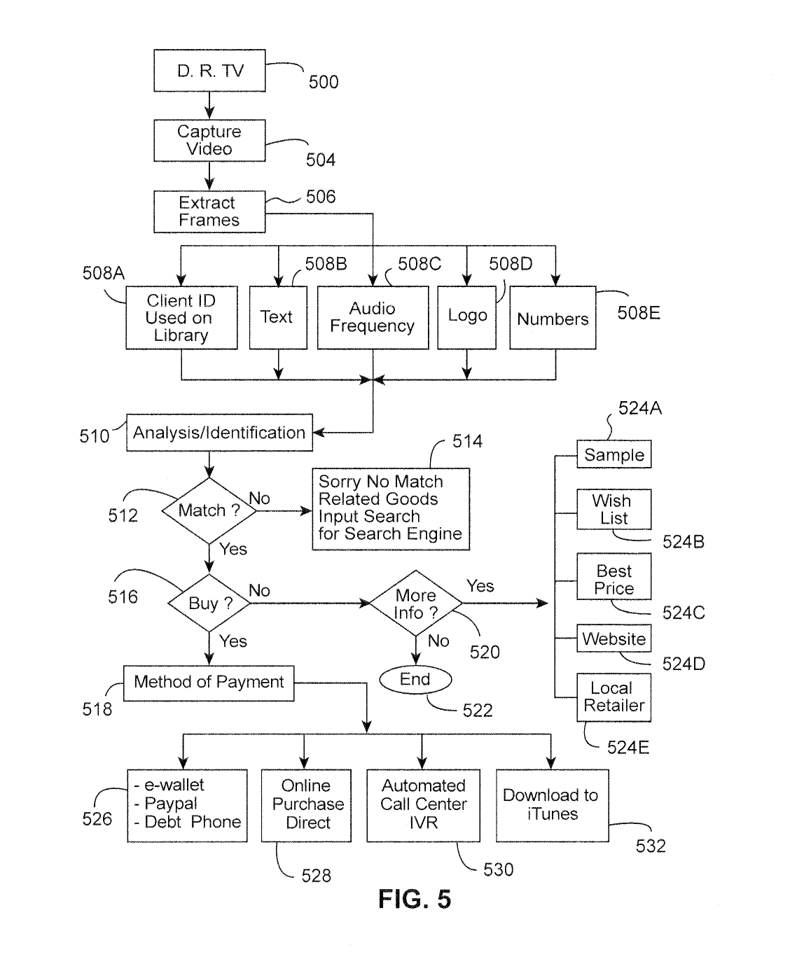

FIG. 5 shows an exemplary process for processing direct response televisions according to certain example embodiments. As discussed above, direct response advertising may be identified at 500. Capture video 504 and/or extracted frames 506 may be used to perform an analysis process on the given content. In certain example embodiments, one or more analysis processes may be used for the content in question. For example, a client (e.g., a business or customer) may have associated this particular piece of content with their client ID. Accordingly in 508A, the client ID that is associated with the content may be determined. In 508B, text that is associated with the content may be extracted and/or analyzed. For example, the name on a car or name on a shirt may be recognized. In 508C, the audio frequency(s) may be extracted and/or analyzed from the content. In 508D, logos that are in the piece of content may be extracted. For example, the logo of a car or shoe manufacturer may be identified. In 508E numbers that are in the content may be extracted. For example, “26” from FIG. 2A may be extracted from the shown television picture. As part of 508A-508E, the system may query a database or perform additional analysis on the given, extracted piece of content.

Accordingly, based on the individual determination in 508A-508E and analysis and/or identification may be performed in 510. This may include determining what product, person, place, service, or the like is associated with the determined content. For example, in FIG. 2A the system may determine that the player with the jersey “26” is Frank a favorite of a user.

In certain example embodiments, various actions may be taken once a product, person, place, service, or the like is identified. In FIG. 5 a report is given to the user as to whether or not a match 512 based on the content submitted has been found. If there is no match, a report is returned to the user indicating as such. In certain example embodiments, when a no match report is returned to the user, additional options 514 may be presented to the user. For example, a related goods search may be offered to the user. This may include presenting other car types to the user if the user submitted media that included a car. In certain example embodiments, the user may input additional or supplemental parameters for a further search. In certain example embodiments, the user may resubmit the piece of media that was analyzed.

If a match is identified, the user may be presented with an opportunity to buy a product, service, etc. at 516. Here, the user may select not to pursue the option to buy and select “no.” In this case, the user may be presented with an opportunity to view additional information 520. If the user again selects no, the interaction ends at 522. If the user selects yes and desires more information at 520, then one or more additional pieces of information may be presented to the user. For example, a sample may be displayed or offered to the user at 524A. The user may add the product to their wish list 524B. The user may be shown a listing of retailers that offer the product and the best prices at 524C. In certain examples, the user may be provided with a website link 524D (e.g., to Ford's website). In certain examples, the user may be given a map to a local retailer 524E that has the product in question.

If, however, the user selects to buy the product, a payment processing system 518 may be enabled. For the payment process, different types of payment options may be available to the user. For example, e-wallet, PayPal, or a debit phone option (e.g., charged directly to the user's mobile phone plane) in 526 may be used. In certain example embodiments, a direct online purchase 528 may be used (e.g., from a retailer website). In certain example embodiments, the user may have the option of connecting to a call center 530 that can process the user's order. In certain example embodiments, a specialized application on the user's mobile device may be used, such as, for example, iTunes 532.

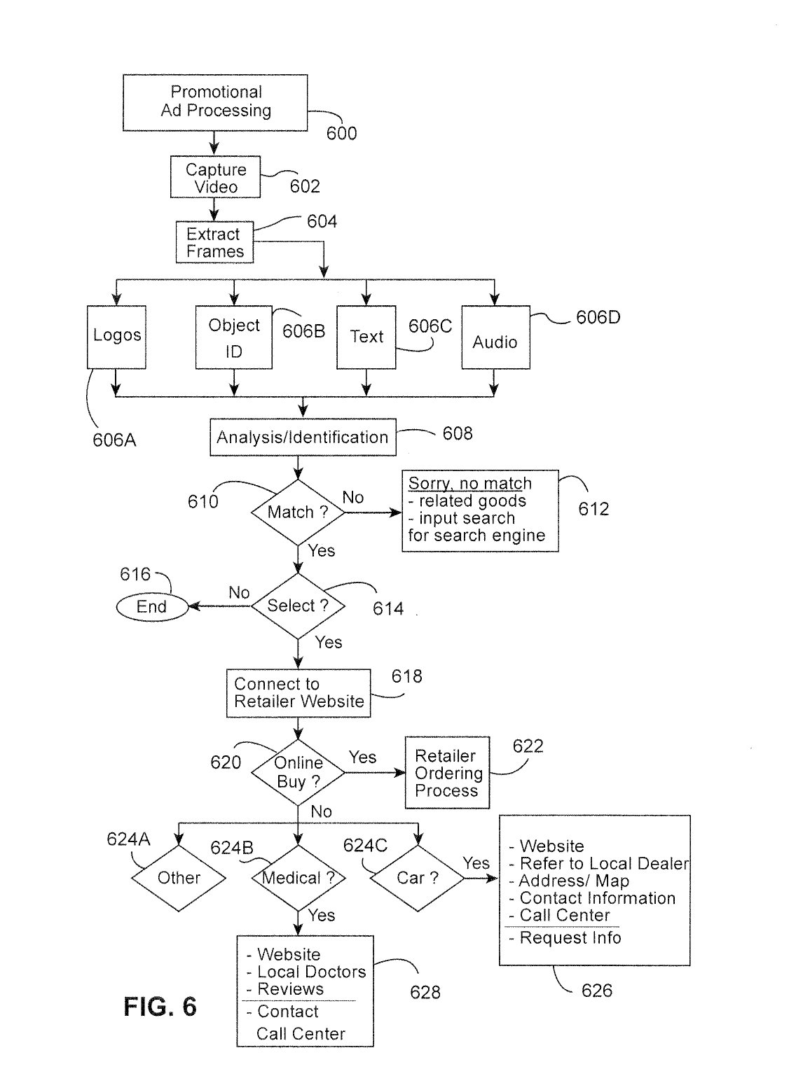

FIG. 6 shows an exemplary process for promotional advertisement processing 600 according to certain example embodiments. Video may be captured in 602 and frames of the video may be extracted in 604. Logos 606A, an object ID or a client ID may be associated with the video or frame in 606B, text displayed in the video may be identified at 606C, and audio streams may be separated and processed at 606D.

Based on one or more of the above pieces of information, an analysis/identification process may be performed at 608. At 610 the system may determine if a match is found. If no match is found, such a result may be presented to the user at 612. In certain example embodiments, as explained herein, the user may then have the option of requesting information on related goods or inputting additional search information. Such additional information may then be returned to the user with additional options.

If there is a match found, a user may select at 614 to purchase to the product. If the user declines to pursue this option, the process ends at 616. If the user does select the product then the user may be connected to a retailer website at 618. Once connected to the retailer website, the user may choose at 620 to buy the product at 622. The purchase process may be similar to the normal retailer processing for the website. In certain example embodiments, a referral fee or the like may be provide for the analysis and identification service that matched the media content to the product being purchased (e.g., a commission fee).

If the user does not wish to purchase the product online at 620, then the user may be allowed to view other information 624A (e.g., about other products). In certain example embodiments, the product or service may be classified in a medical area. In this case, the user may be given extra information 628 regarding health information, local doctors, reviews of products and/or services, or the option to contact a call center (e.g., to setup a medical appointment, order products, ask medical questions, etc). In certain example embodiments, the product in question may be determined to be a car in 624C. If the product is a car, then additional information may be provided to the user (e.g., a website, information on a local dealer, address of the dealer, along with contact information). In certain instances, the user may be offered the option to request additional information. For example, technical details on certain aspects of the car.

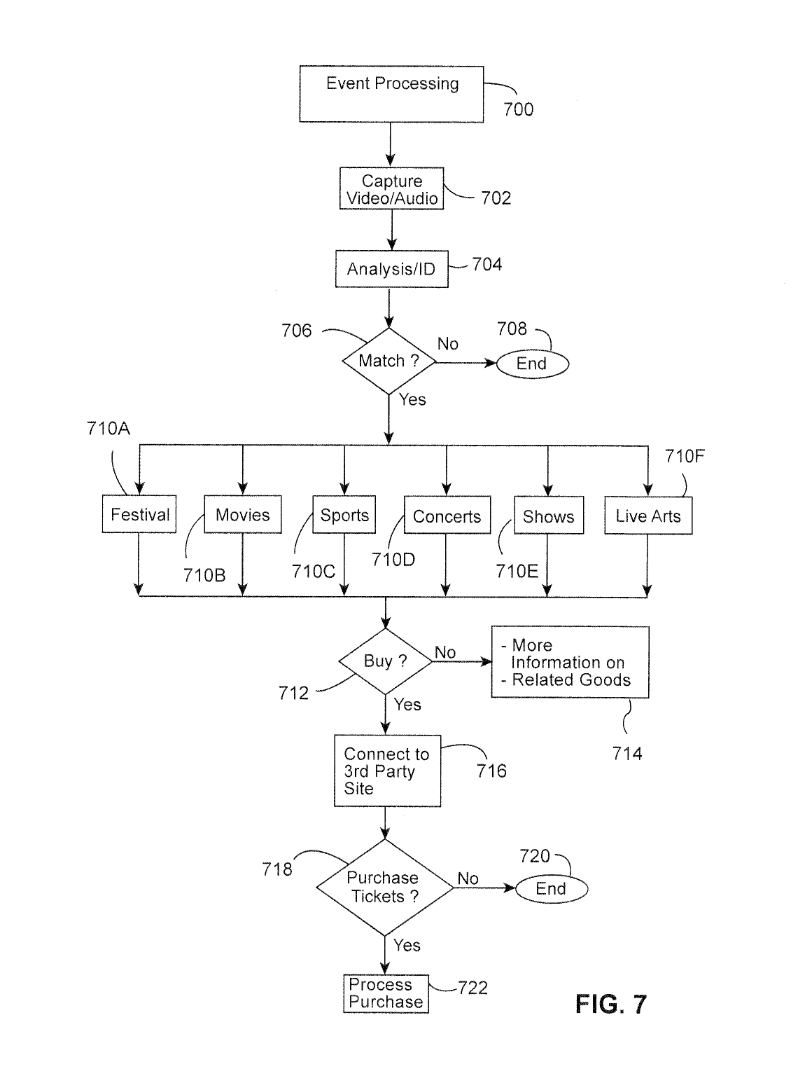

FIG. 7 shows an exemplary process for event processing according to certain example embodiments. Certain types of media content may relate to events (e.g., concerts, rallies, etc). Media related to events may be processed at 700 via capturing video and/or audio 702 and subsequent analysis thereof at 704 to determine if there is a match 706 in the content database. If no match is found the process may end at 708. If there is a match it may be classified as being associated with one or more types of events. For example, a festival 710A, movies 710B, sports 710C, concerts 710D, shows 710E, live arts 710F.

Depending on the type of event, the user may be offered a chance to purchase tickets to the event in question at 712. If the user declines they may be presented with more information on goods/services that are related at 714. If the user decides to pursue a purchase they may be connected to a third party site 716. In certain example embodiments, the payment process may be handled internally with the analysis of the media content. The user may be presented with another chance to exit out of the ticket buying process at 718. If the user decides to stop, then the process ends at 720. If the user still desires to purchase tickets, then a purchase process may be presented to the user at 722. In certain example embodiments, the media analysis system may present the user with an immediate buying opportunity (e.g., 1-click shopping).

It will be appreciated that other types of content may be processed. The content may be, for example, content from a television or may be so called “user-generated” content in which the user submitted content is of real objects.

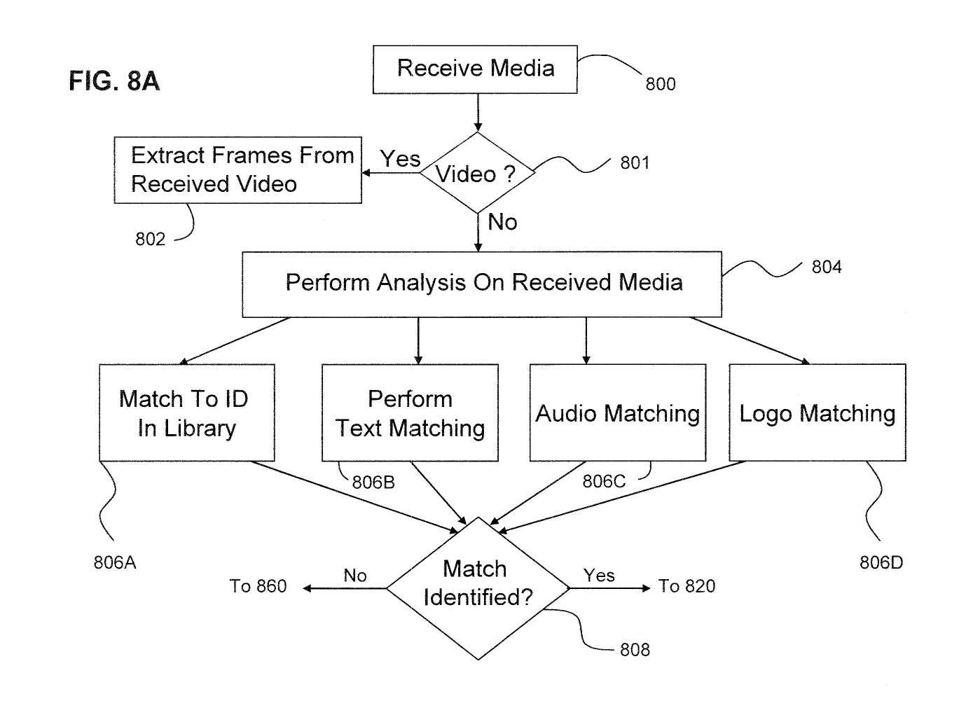

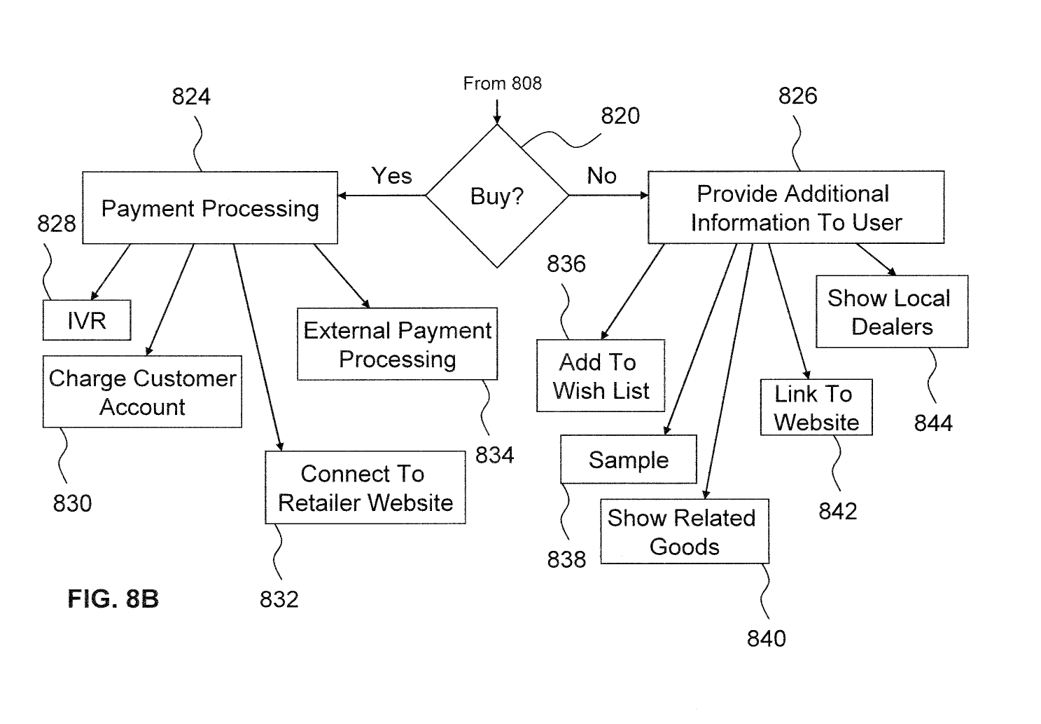

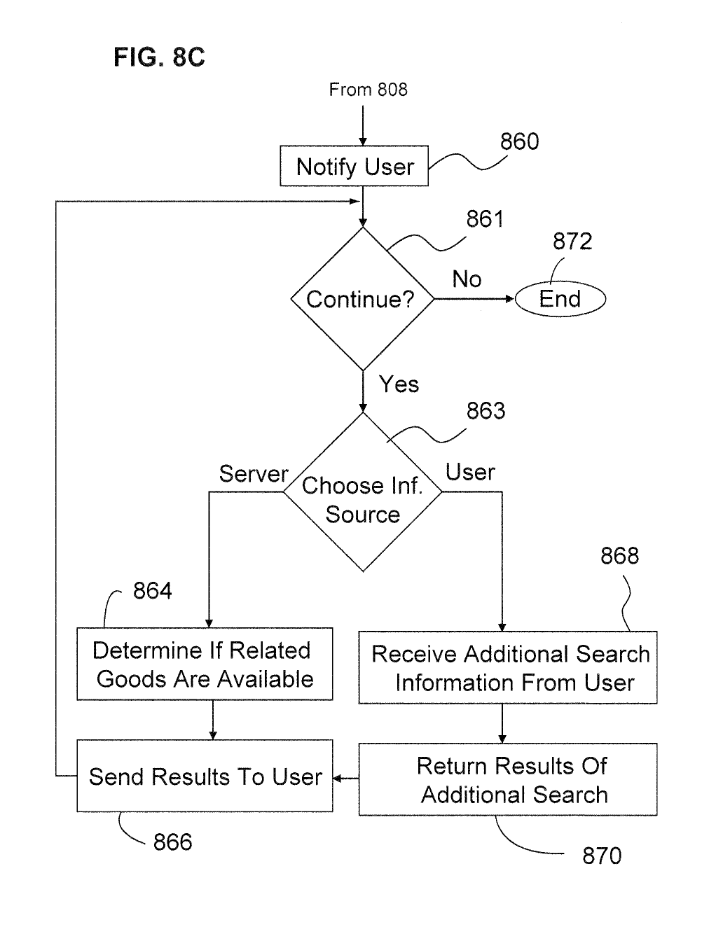

FIG. 8A is an exemplary process for matching media content according to certain example embodiments. In step 800 media content may be received from a user with a mobile phone. A check may be performed at 801 to determine if the media uploaded by a user is a video. If the content is a video then at 802 frames from the video may be extracted to produce a series of images. Accordingly, in 804 an analysis may be performed on the received media content. In certain example embodiments, the frame extraction process may be skipped and the video may be analyzed, or the extraction process may happen during the analysis process.

In any event, as part of the analysis process in 804, and ID that is associated with the uploaded media content may be matched to a stored library of content at 806A. For example, certain media may have embedded IDs based on who is uploading or where the content is being uploaded from. At 806B, any text that is shown in the media may be identified and analyzed. At 806C audio may be extracted from video media content. Logo's that are present in the media may be automatically identified 806D. For example, the logo of a sports team may be identified. Based on the above analysis processes a match may be identified at 808. In certain example embodiments, the matching of uploaded media to products and/or services may include manually identifying a product in uploaded media. Thus, for example, a user may upload media to an example service which may perform automatic text matching in conjunction with a manual process performed by employees or contract workers. The manual matching process may be used independently or in conjunction with other automatic processes.

If there is a match identified the process proceeds to 820 in FIG. 8B. However, if the processed media content is not matched with a product, service, etc, then the process may proceed to 860 in FIG. 8C.

FIG. 8B is an exemplary process for buying a product as a result of matched media content. If the media that has been processed in FIG. 8A is matched with a particular product, service, etc (or a group thereof), a user may be presented with an option to buy the matched item on their mobile device at 820. When the user selects “yes” the process proceeds to a payment processing option 824. Here, a user may select from one or more of: an IVR 828; charging their account 830; connecting to a retailer website 832; or external payment processing (e.g., a credit card transaction or the like) 834. In certain example embodiments, a user may set a default option that is stored in an exemplary system described herein such that the user does not have to select a payment option. Under such conditions, the user may then simply select to “buy” a product at 820 and based on this stored information the product may be “automatically” purchased for the user. In certain example embodiments, a pass phrase, pin, or other primary or secondary authentication scheme may be implemented.

If the user decides not to purchase the goods/services at 820 then an exemplary system may provide additional information to the user at 826. For example, an option may be presented that allows the user to add the matched product to a wish list 836 that is associated with the user's account. In certain example embodiments, a sample 838 may be provided to the user. This may be a sample for the good involved or the service that is to be provided (e.g., a clip of a movie, a sample pack of perfume, etc). Another option that may be presented to the user is an option showing goods that are related to the matched good at 840. For example, the matched good in question may be from brand A. Thus, the system may also have information on brand B, a competitor of brand A. In certain example embodiments, businesses may partner with a provider of the matching system to always or sometimes show their products to users whenever a similar product is matched.

In other instances, a person may be given the option to link to a website 842. The website may be the website of the company's related good/service or may be another type of site. For example, the linked site may be a review site (e.g., a car article from Consumer Reports or the like). In certain example embodiments, a dealer in the product/service being offered may be shown to the user at 844. As part of this information a map to the dealer may also be shown.

As discussed above, a match for a given product may not be found based on the uploaded content. This may happen because the media is of poor quality, the product/service in question has not been indexed by the service, or the business that makes/provides the product or service is not a partner of the media analysis provide. Thus, FIG. 8C is an exemplary process that is used when no matches are found based on the media provided by the user. If there are no matches found a notification is sent to the user in 860. After receiving the notification the user may be asked if they wish to continue or stop the process at 861. If the user desires to stop, the process ends at 872. If the user desires to continue they may be presented with a choice of pursuing further information at 863. In certain instances, this may include providing additional search information 868. Such information may include further features of the product that is being searched for. Accordingly, in certain example embodiments, the additional information provided by the user in 868 may be paired with the earlier information regarding the media content. In certain examples the search may be an entirely new search that is independent of the earlier provided media content. In any event, results based on the search information may be determined in 870. The results may then be sent to the user in 866 (e.g., to the user's mobile device). In certain example embodiments, the process may end after returning the results. In certain examples, the process may ask if the user desires to conduct another search by returning to 861. In certain examples, the results of the search process may provide the opportunity to purchase the good/service being search for (e.g., as described in FIG. 8B)

Alternatively, or in addition, to providing additional search results, the system may determine goods that are related to the media content that is provided by the user at 864. If there are any goods, the results may be sent to the user in 866. In certain example embodiments, goods that are related to good or service in the uploaded media content may be presented to the user. For example, if the good in the uploaded media content is from company A, the system may shown goods from company B that are stored in an exemplary media processing system. As with the above discussion, a user may end the additional search functionality, provide further search options to the user, and/or allow the user to proceed with a purchase for a user.

As discussed herein, different types of content may be processed by a media processing system. In certain example embodiments, the system may have access to media content in order to enable analysis of the uploaded media content. Thus, for example if a user records a video clip of a football game being shown on television, the system may also have the same football game already in its database (e.g., because it is stored/processed “live”).

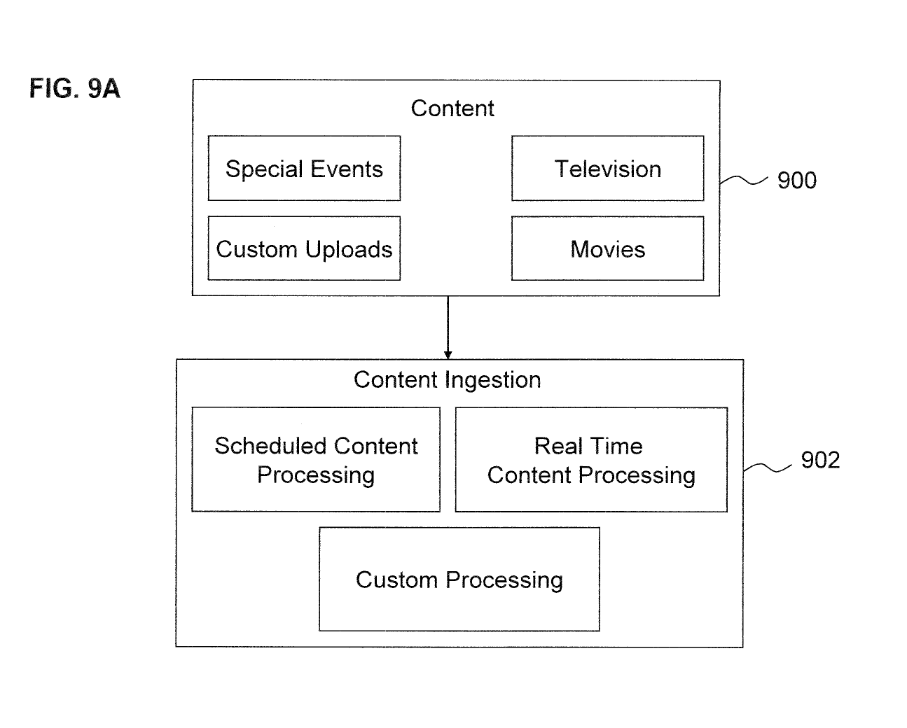

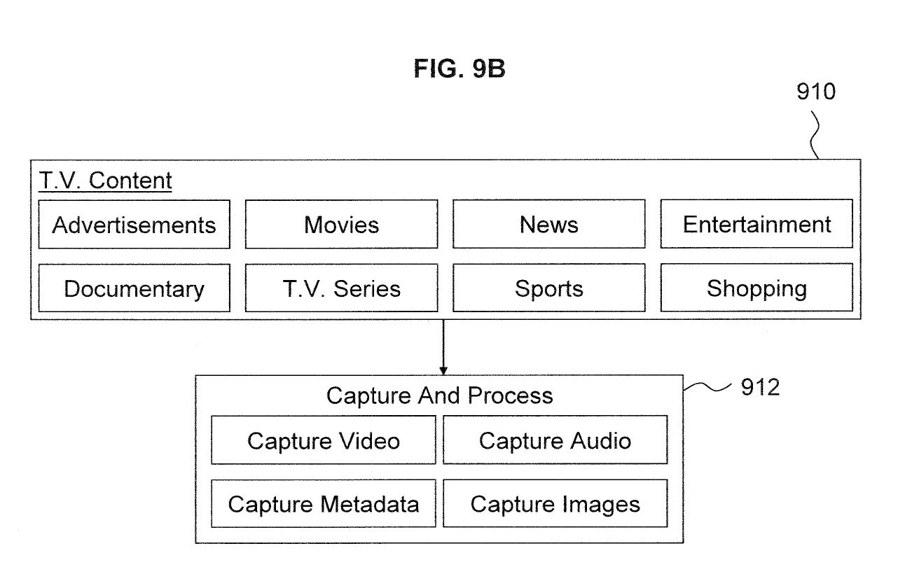

FIG. 9A is an example block diagram showing content ingestion according to certain example embodiments. The ingestion 902 of content 900 may include content from special events (e.g., concerts, rallies, etc), regular television shows (e.g., sitcoms), movies (e.g., feature length films shown at a theater), custom uploads. In certain example embodiments, custom uploads may be uploads that are created for an example service/system described herein. For example, a car company may create various movies, images, sounds of one of the automobiles that are produced. This custom content may be used to assist in an exemplary analysis process when a user uploads a piece of content (e.g., when user 104 in FIG. 1 uploads a movie or picture that includes car 100).

The ingestion of content may also be scheduled (e.g., based on a television network schedule). The ingestion may include real-time processing. For example, sports broadcasts are typically “live” broadcasts. In order to provide, for example, user 202 in FIG. 2A with the opportunity to retrieve information on player 26, the game being broadcast may be uploaded and stored in a database in a real-time. Thus, the system may be able to process a user uploaded clip from the same game.

FIG. 9B is an example block diagram for T.V. content processing according to certain example embodiments. Different types of T.V. content 910 may be stored in an example system. For example, advertisements, movies, news, entertainment (e.g., the Oscars), documentaries, T.V. series, sports programs, shopping network presentations, and/or the like may be stored in an exemplary system. The various content types may then be captured and processed at 912 through various techniques. For example, a video stream of the program may be recorded, the audio of the program may be recorded, and metadata (e.g., broadcast time, name of show) may be saved. In certain example embodiments, images may be extracted from a video stream. This may allow for example, a space efficient way of storing the content information (e.g., instead of storing the full T.V. show at 30 frames per second). In certain example embodiments, during the content ingestion process the content may be annotated or tagged with extra “meta” information. For example, a particular scene from a T.V. show may be tagged and/or associated with a product that is used in the show. For example a particular type of car (e.g., an Aston Martin from James Bond) may be tagged into a James Bond movie for scenes in which the car is shown.

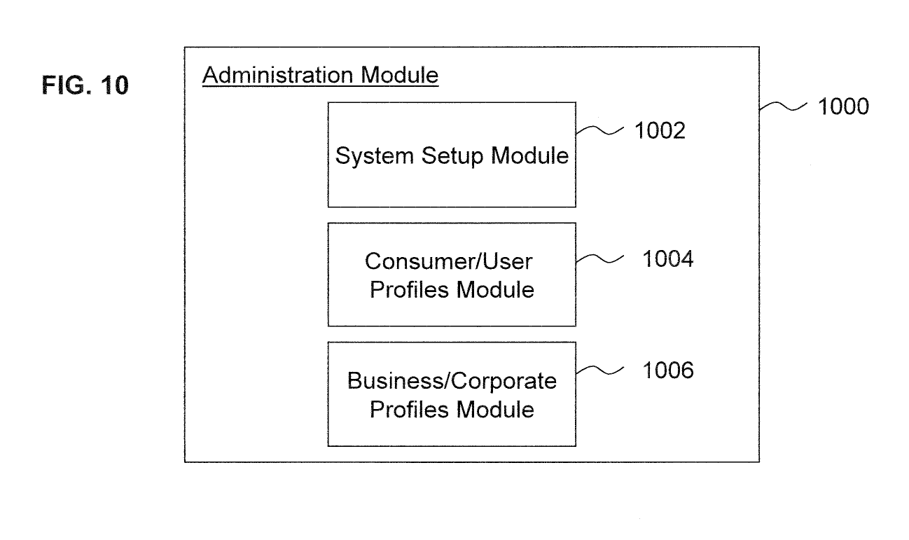

FIG. 10 is an administration module according to certain example embodiments. A content analysis and storage system may include an administration module 1000 that provides certain administrative functionality for the operator of the system. A system setup module 1002 may be used for maintenance and/or setup of the central analysis and content storage system. For example, servers may be assigned, content ingestion rules may be defined, etc. The administration module 1000 may include a consumer or user profile module 1004. This module may allow users to set preferences and user information such as, for example, name, email, telephone number, payment options, billing information. This module may also allow users to link particular mobile devices to their accounts. This may involve linking unique identification information from the mobile device (or SIM card) to a user's profile. The profile module 1004 may also include functionality that tracks the usage or purchase history of a user. This may allow, for example, the system to improve analysis of media uploaded by a user. In certain example embodiments, the purchase history of a user may facilitate product suggestions if no service/product is found based on uploaded content from a user. The product history of a particular user may help in matching uploaded content to stored media content by providing a “hint” as to what type of content is being uploaded. For example, if a user always uploads sports related content, the system may search the stored sports content first when analyzing the uploaded content from this particular user.

The administration module may also include a business/corporate profile module 1006. In certain example embodiments, this module may allow business partners to upload content to the service. The content that is uploaded may include additional metadata. In certain example embodiments, this module may allow users to specify how products are presented to users when a match is found. For example, a company may desire to have users directed to their company website.

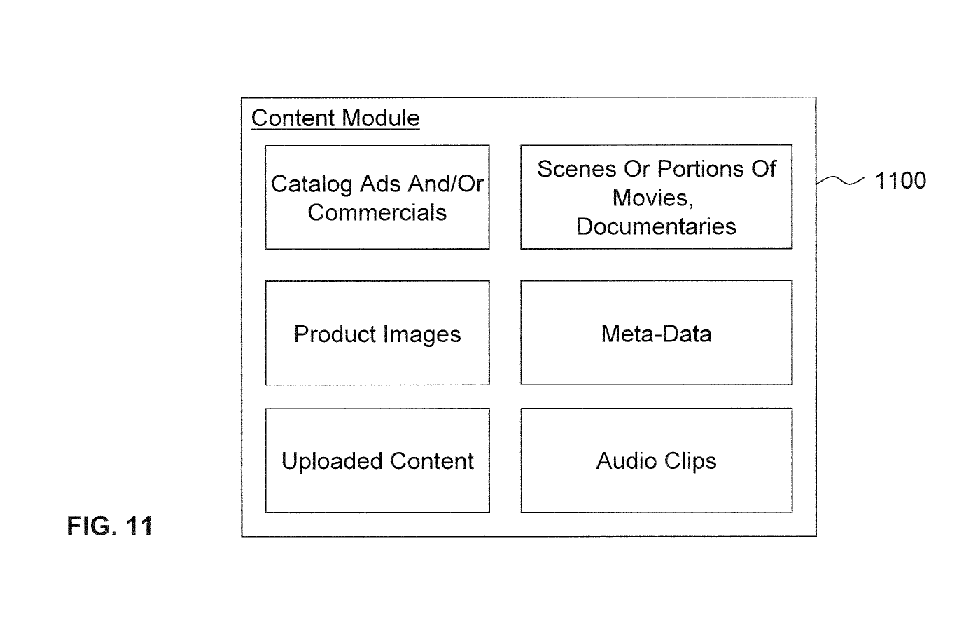

FIG. 11 is a block diagram of a content module according to certain example embodiments. The content module 1100 may store content that upload by a user or ingested content. An example content module 1100 may include a catalog of advertisements, scenes from T.V. shows, product images (e.g., a picture of a car), meta-data that is associated with various other content (e.g., images, audio, movies), custom uploaded content, and/or audio clips.

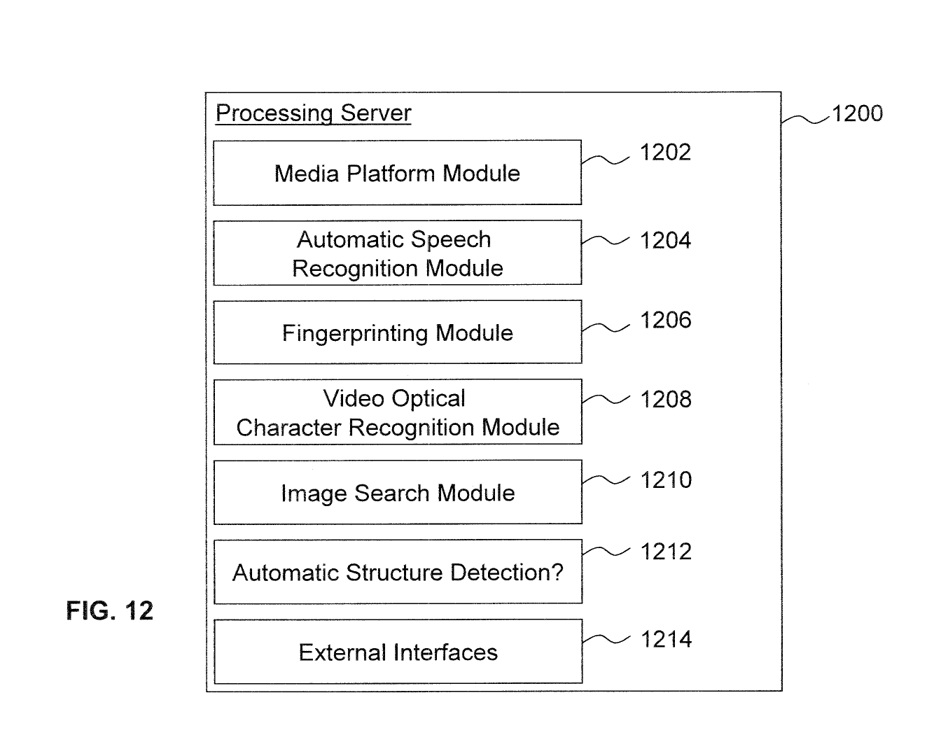

FIG. 12 is a block diagram of an example processing server that includes multiple different modules according to certain example embodiments. A processing server 1200 may be one or more physical servers (e.g., a cluster or server farm). A media platform module 1202 may be provided. This module may tag media content though the automatic processing of channels (e.g., TV channels, internet sources, etc). Tagged information may include: Program type, for example: movies, documentary, sports (e.g., NFL, NBA), news, music, T.V. shows, commercials (e.g., Advertisements); Time of transmission or broadcast, for example: country, region, city, channel #, network (e.g., HBO, NBC, ABC). In certain instances, the module 1202 may provide libraries for content/data to search over. For example, the libraries may include: cars, bicycles, different types of sports (e.g., golf, football, etc).

In certain example embodiments, the module 1202 may provide multi-language support for users to interact with certain services in more than one language (e.g., English, Arabic, and Spanish).

In certain example embodiments, the module 1202 may accept uploads of advertising content with tagged information. In certain instances, such information may include, for example: scene information; frames of the advertisement; a logo associated with the advertisement speech data (e.g., a fingerprint for speech in the advertisement); VOCR textual data; a telephone number (e.g., for linking to an IVR); possible actions that may be taken in relation to an advertisement being triggered (e.g., connect to purchase the good or connect to a website); geographical data (e.g., national, regional, or local listings).

An automatic speech recognition module 1204 may be provided for automatic speech recognition of uploaded content or content that is stored in the content database (e.g., to determine if a character in a sitcom mentions a particular product). A fingerprinting module 1206 may be provided to determine unique characteristics of stored or uploaded content. This may be accomplished by an analysis of the advertisements based on the sound, colors in the ad, or other information that may provide a unique (or nearly unique) fingerprint of an advertisement (or other content) to allow for a quick analysis and matching process.

A video optical character recognition module 1208 may be provided to allow for analysis of text that shown in an image or video. An image search module 1210 may be provided to facilitate imaging searching based on an image that has been uploaded by a user. An automatic structure detection module 1212 may be provided. In certain example embodiments, structure detection may include detection of the structure of uploaded video or audio content. For example, detection of commercial segments versus content from a T.V. show.

The processing server may also include interfaces 1214 to external systems. Such interfaces may allow communication between third party providers. For example, credit card processing, call centers, or services provided by business partners (e.g., through web services) may be accessed through interfaces maintained and/or provided in the external interface module.

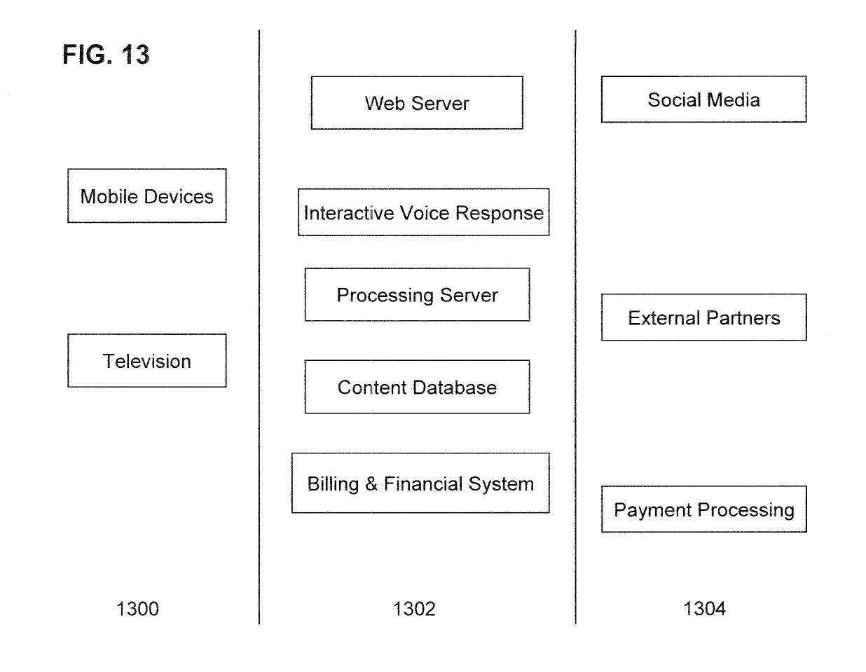

FIG. 13 is a diagram showing example components of systems, apparatus, and/or services according to certain example embodiments. In certain example embodiments, a media analysis system that is operated by a provider may include systems in section 1302. For example, a web server may allow users view products. Interactive voice response may provide the ability for a user to speak into their mobile device to interact with the provided system. As explained herein, a processing server may analyze uploaded media content. A content database may store content that the user uploaded media content is compared against. A billing and financial system may also be provided. It will be appreciated that the various components/systems may be provided by other third parties (e.g., as hosted services or the like).

Section 1304 may include those services that are hosted by third party providers or partners. The systems in section 1302 may interact with these systems. The systems may include social media (e.g., facebook, twitter, etc). In certain example embodiments, section 1304 may include external business partners that partner with the media analysis provider in the form of content for the content database (e.g., television station feeds). Section 1304 may also include payment processing (e.g., credit card processing systems).

Section 1300 may include those systems that are operated by a user. For example, a mobile device that is used for uploading media content that is to be analyzed by the systems in section 1302. Thus, the mobile device in section 1300 may communicate with one or more of the systems in section 1302 (e.g., for uploading content) and/or 1304 (e.g., for payment processing).

It will be appreciated that one or more of the systems, devices, etc. shown in FIG. 13 may be moved to other sections. For example, the billing and financial system may be a hosted service and provided in section 1304. Further one or more of the systems may communicate and/or interface with other systems that are in the same section or a different section.

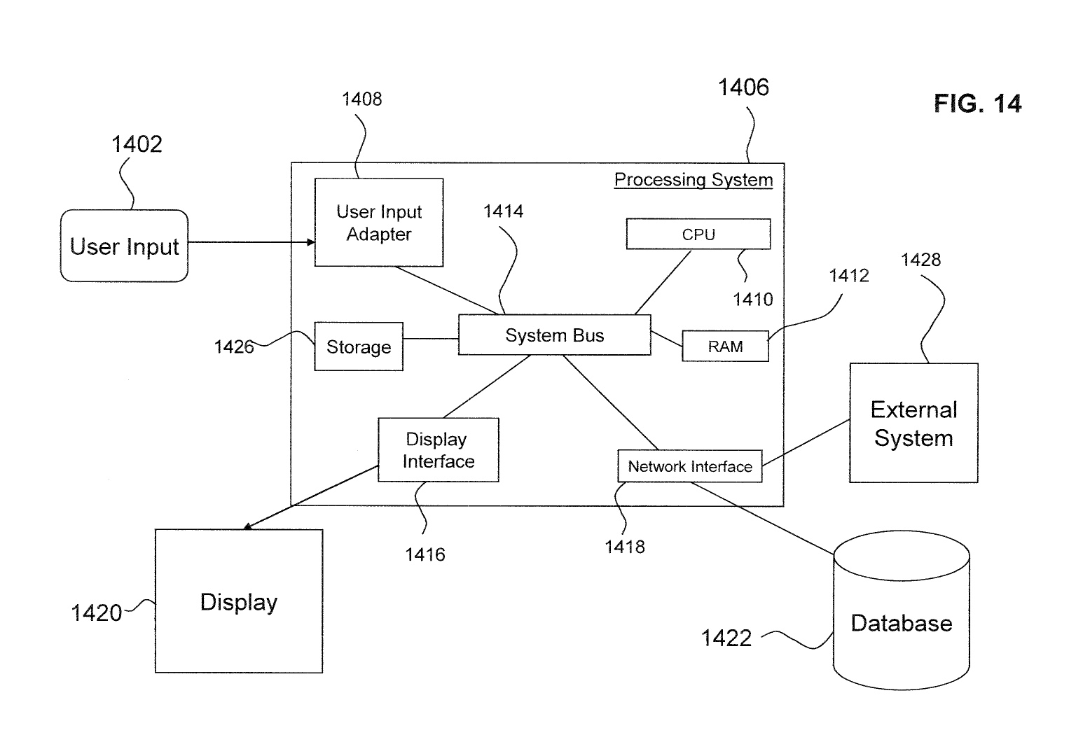

FIG. 14 is an example processing system according to certain example embodiments. Processing system 1406 may have a user input device 1402 such as a keyboard, mouse, touch screen, or the like connected to a user input adapter 1408 of the processing system 1406. The user input adapter 1408 may communicate with a system bus 1414. The system bus 1414 may communicate with storage medium 1426, CPU 1410, and RAM 1412. A display 1420 that may be, for example, a LCD display, a television display, or the like, may communicate with a display interface 1416 of the processing system 1406.

The processing system 1406 may also include a network interface to facilitate communication with a database 1422. In certain example embodiments, the database 1422 may store recorded or indexed content (e.g., a television show or the like). The database 1422 may store other data as well, for example, user profile information, or user upload media that is to be processed, etc. The network interface 1418 may also interface with external systems 1428. Example external systems may include, for example, partner web services, web site links, credit card processing systems, etc.

In certain example embodiments, the processing (or analysis) of user generated content may be accomplished on the mobile device of the user. For example, the mobile device may maintain a database of products. The analysis (e.g., pattern recognition) of the user generated content may be performed on the device and products stored in a database on the mobile device may be associated with the created content/media. Thus, for example, the mobile device may include an application that communicates with a service to download product information that is used for analysis. In certain example embodiments, the download of product information may be by category. For example, a user may download product data on cars. Thus, the user may be able to take a picture on the mobile device and have the picture analyzed by the mobile device which may then return information of a good stored in a database on the mobile device.

It will be appreciated that the steps or processing of information (e.g., of user uploaded content) may be performed on a user controlled device (e.g., a mobile device), a processing system of a provider, and/or a third party partner.

In certain example embodiments, an example media analysis system may determine what content within the uploaded media should be matched to stored content. For example, when a user uploads a short video clip from a television show to the processed, the media analysis system may determine a portion of the video (or image) includes a television picture in it. Thus, certain extraneous information may be removed from the video (or image) to facilitate the analysis (e.g., matching) process described herein. For example, background information in the image (or movie) that is not displayed on the T.V. screen may be removed. In certain example embodiments, the user may define a particular section of an image/movie that the analysis process may focus on.

In certain example embodiments, more than one product or service may be associated with a given piece of content. For example, a 5 second video clip of a football game may include multiple goods/services that may be presented to a user as a result of uploading the clip for analysis. For instance, an option to purchase a jersey of one or more players that are shown in the video may be displayed. Additionally, an option for buying tickets to the next home (or away) game may be displayed to the user. Indeed, in certain example embodiments a large number of options may be displayed. These options may be defined by the partner business, the user (e.g., I only want to see buy it now links, not extra information), or by the provider of the media analysis service.

In certain example embodiments geographical data may be used to assist in identifying a service, product, place, etc that is associated with a picture. For example, a user may take a picture of the front of a restaurant. The user may upload the picture to a processing service and may include geographical data regarding where the picture was taken. Based at least in part on the text within the picture and/or the geographical data the processing server may analyze the picture to determine the service (or place of business) in question is “Ray's Pub.” The processing server may then send data including reviews for the restaurant to the user's mobile device, offers to book a table, etc. In certain example embodiments the services (e.g., to book a table) may be provided through third party providers and/or through internally provided services.

In certain example embodiments, user may intact with other users (e.g., friends and family) to pass along products and/or user generated content to other users. For example, a user may send a picture or clip to another user. This clip may also be also shared with the associated products or services. For example, after received results of an analysis, the user may forward those results along to another user. In certain example embodiments, user generated content may be submitted but the results may be returned to a user who did not initially submit the content. For example, the user may include the email address or mobile device number of the person who the results should be forwarded to. In certain example embodiments, such sharing may be integrated into various social media services (e.g., facebook, twitter, etc).

In certain example embodiments, if a second user ends up buying a product that a first user forwarded to the second user, the first user may get a commission based on the sale. The forwarding of information in such a manner may be a tightly controlled process (e.g., opt-in) or may be more loosely controlled to allow for greater flexibility in forwarding content (e.g., an opt-out system).

### Use Cases

In certain example embodiments, a gardening application is provided that allows users to capture content related to nature and obtain information, such as products or services, related to the captured content. For example, a hiker in a public park may see a particular flower and wonder if there is a domestic variety of the flower. With this embodiment, the hiker may take a picture and receive information on the type of flower, where cultivated varieties may be purchased (e.g., a nearby nursery), and/or tips on caring for such a plant.

In certain example embodiments, promotional television advertisements are captured. Various types of merchandise (e.g., kitchen appliances, clothes) or services may be shown to a user while the user is watching television. These advertisements may be “long-form” (e.g., 30 minutes) or “short-form” (e.g., 30 second spots). A user watching such advertisements may use their mobile device to create media content (e.g., audio and/or visual) related to the advertisement. The products discussed in the advertisement may be identified (by a remote service or the mobile device). Once a product or service is identified the user may purchase the same through the mobile device.

In certain example embodiments, a celebrity shopper application is provided. A user watching a television show or a movie may desire to purchase clothing that the actor or actress is wearing. For example, the user may be watching the red carpet ceremony at the Academy Awards. The user can use their mobile device to capture media content that shows the actor or actress wearing a particular clothing style. The clothing in the picture may be identified (either on the mobile device or a remote service) and an opportunity for the user to buy the same (or similar) directly through their mobile device may be presented. In certain examples, similar types of clothing may also be presented to the user (e.g., a less expensive version of a $5000 dress).

It will be appreciated, that the above use cases are discussed by way of example. In certain instances, all of the above techniques may be performed by a mobile device. In certain other cases, only specific applications may be configured on a mobile device.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

We claim:

1. A method of providing information to a mobile device that senses humanly perceivable media content, the mobile device operable to communicate with an information processing server, the method comprising:
maintaining, on the information processing server, an informational database linking media content with product and/or service offers;
analyzing at least a portion of a media stream sensed by the mobile device;
correlating, using at least one processor, the sensed media stream portion with the linked media content;
based on the correlating, selecting, using the at least one processor, at least one product and/or service offer linked to the media content; and
sending the selected at least one product and/or service offer to the mobile device.

2. The method of claim 1, further comprising obtaining the media content, the media content being from a media source that is different than the mobile device.

3. The method of claim 2, further comprising:
analyzing the obtained media content; and
storing a result of the analysis as the information related to media content.

4. The method of claim 1, further comprising:
receiving a buy response from the mobile device that is based on the sent selected at least one offer of the product and/or service, the buy response indicating that a user of the mobile device desires to purchase the product and/or service.

5. The method of claim 4, further comprising:
linking the mobile device to a third party provider to facilitate purchasing the product and/or service.

6. The method of claim 1, further comprising extracting at least one frame from the portion of the sensed media stream,
wherein the portion of a sensed media stream is a movie file that has been recorded via the at least sensor of the mobile device, and
the correlating includes identifying at least one feature from the at least one frame.

7. The method of claim 6, wherein the at least one feature includes textual content.

8. The method of claim 6, wherein the at least one feature includes audio content.

9. The method of claim 6, wherein the at least one feature includes a logo that is displayed within the at least one frame.

10. The method of claim 6, wherein the at least one feature is a plurality of features.

11. A processing server system that analyzes media content provided from a mobile device that includes at least one sensor configured to sense humanly perceivable media content, the system comprising:
a non-transitory memory storage system that is configured to store an informational database related to media content; and
at least one processor that is configured to:
store, to the informational database, information related to media content;
store, to the informational database, an association between at least one offer of a product and/or service and the information related to media content;
receive at least a portion of a sensed media stream from the mobile device;
correlate, via at least one processor, the received media stream to the stored information related to media content;
select at least one offer of a product and/or service that has an association to the correlated information related to media content; and
send the selected at least one offer of the product and/or service.

12. The system of claim 11, wherein the at least one process is further configured to receive the media content, the media content being from a media source that is different than the mobile device.

13. The system of claim 12, wherein the at least one process is further configured to:
analyze the received media content; and
store a result of the analysis as the information related to media content.

14. The system of claim 11, wherein the at least one processor is further configured to receive a buy response from the mobile device that is based on the sent selected at least one offer of the product and/or service, the buy response indicating that a user of the mobile device desires to purchase the product and/or service.

15. The system of claim 14, wherein the at least one processor is further configured to facilitate linking the mobile device to a third party provider to facilitate purchasing the product and/or service.

16. The system of claim 11, wherein the at least one processor is further configured to extract at least one frame from the portion of the sensed media stream,
wherein the portion of a sensed media stream is a movie file that has been recorded via the at least sensor of the mobile device, and
the correlating includes identifying at least one feature from the at least one frame.

17. The system of claim 16, wherein the at least one feature is: 1) textual content within the first media content; 2) audio content within the first media content; or 3) a logo that is displayed within the first media content

18. The system of claim 16, wherein the at least one feature is a plurality of different types of features.

19. The system of claim 11, wherein the sensed media stream is a recording of television content displayed by a television and the media content has been obtained via a program feed for the television content from a content provider source.

20. A system for outputting responsive messaging content, the system comprising:
an output device configured to output humanly-perceivable messaging content;
at least one sensor configured to sense humanly-perceivable media content; and
a processing system including at least one processor, the processing system configured to:
capture, via the at least one sensor, at least a portion of a media stream; and
output to the output device, humanly-perceivable messaging content based on determined correspondence between captured and predetermined media streams.
